(19) United States
(12) Patent Application Publication
(10) Pub. No.: US 2008/0249984 A1
(43) Pub. Date: Oct. 9, 2008

(54) Use of Graphical Objects to Customize Content

(76) Inventors: Srinivas J. Coimbatore, Morrisville, NC (US); Peter C. Yim, Raleigh, NC (US); John K. Muller, Orlando, FL (US); Jason T. Clark, Raleigh, NC (US)

Correspondence Address: HAMILTON & TERRILE, LLP;IBM RSW, P.O. BOX 203518, AUSTIN, TX, 78720, US

(21) Appl. No.: 11/695,785

(22) Filed: Apr. 3, 2007

(51) Int. Cl. G06F 17/30

(52) U.S. Cl. 707/3

(57) ABSTRACT

A method, apparatus and computer-usable medium is provided for using graphical objects to automate the definition of search queries submitted to an information management system. A search query is defined using a plurality of predetermined search terms represented as graphical objects within a user interface. The search query is structured by spatially referencing the graphical objects to a first area of the user interface, which results in their associated search terms being submitted to an information management system. The results of the search query are then presented in a second area of the user interface. The graphical objects comprise predetermined classifications of information content segmented by the implementation of display attributes. The display attributes depict the information content's source, quantity, format or chronology. The search query results presented in the second area of the user interface change dynamically as the spatial relationship between the graphical objects are changed relative to each other and the first area of the user interface.

### BACKGROUND OF THE INVENTION

1. Field of the Invention

The present invention relates in general to the field of computers and similar technologies, and in particular to software utilized in this field. Still more particularly, it relates to using graphical objects to automate the definition of information search queries and the presentation of their results.

2. Description of the Related Art

The breadth and depth of information available through the public Internet and private intranets continues to grow. The diversity of this information, its vast volume, and its innumerable sources has helped fuel the need for increasingly more sophisticated search and retrieval solutions. These systems may be variously known as search engines, data miners, knowledge management systems, etc. Despite the implementation of sophisticated algorithms and other technologies, many of these solutions continue to be based on key word text searches combined with Boolean operators. In many cases, it is difficult for users of these solutions to formulate successful and meaningful search queries. If the search query is too precise, too few search results may be returned and relevant information may be unintentionally excluded. If it is too broad, the number of results may be overwhelming and contain a high percentage of unrelated information. For example, a query containing the phrase “drug trials” may return millions of results, or “hits”, not just for emerging products in the pharmaceutical industry, but drug related criminal litigation as well. At the same time, pertinent references to “drug testing” may be unintentionally excluded.

One common issue with present search systems is that information can be stored in many different forms, including Web sites or pages that are indexed using the hypertext mark-up language (HTML). Other searchable information formats include plain text referenced by an HTML link, Adobe's portable document format (pdf), and word processing documents in proprietary formats. Information can also be stored in other forms, including spreadsheets and presentations that have their own proprietary file format, as well as graphics, picture, audio and video files. Irrespective of the native format of the information, search results are typically text-oriented and presented as a list of document titles or hypertext links such as uniform resource identifiers (URIs). In general, these search results are ranked by relevance, although some approaches provide the capability to also present results in chronological order.

Regardless of the presentation method, each site, page, document or file must be individually examined to determine its relevance. Furthermore, no given information source is prioritized or treated as being more credible than any other source. As an example, it is entirely possible for uninformed and possibly erroneous comments in a user forum to have the same search results ranking as links to documentation from the manufacturer. Another issue is the current inability of a user to predetermine and adjust the format, chronology, or source ratio of retrieved information. For instance, a user may specify that a search engine only return pdf documents and presentations, but there is no way to determine the relative percentage of each information type available within the search results. Furthermore, the user is likewise unable to specify a desired ratio of information types to be returned within the results.

### BRIEF SUMMARY OF THE INVENTION

The present invention includes, but is not limited to, a method, apparatus and computer-usable medium for using graphical objects to automate the definition of search queries submitted to an information management system and the presentation of their results. In selected embodiments, a search query is defined using a plurality of predetermined search terms, which are represented as graphical objects within a user interface. The search query is structured by spatially referencing the graphical objects to a graphical query window within the user interface, which results in their associated search terms being submitted to an information management system. The results of the search query are then presented in a search results window of the user interface.

In different embodiments, the graphical objects comprise predetermined classifications of information content, which are segmented by the implementation of display attributes applied to the corresponding graphical object. In one embodiment, the display attributes (e.g., size of the graphical object within the user interface) depict the available quantity of a predetermined classification of information content. In other embodiments, the display attributes depict information content source (e.g., Internet, intranet), format (e.g., HTML, pdf), or chronology (<90 days, >2 years). In another embodiment, the spatial relationship of the graphical objects to the graphical query window of the user interface and to each other is configurable to define Boolean relationships for modifying the search query. For example, if two graphical objects are placed through user gesture to be adjoining each other, then a Boolean AND operation is applied to the search query. In one embodiment, the degree of intersection between two or more graphical objects determines the degree of commonality for search results.

In these and other embodiments, the search query results presented in the search results window of the user interface change dynamically as the spatial relationship between the graphical objects are changed relative to each other and the graphical query window. For example, if a graphical object is moved out of the graphical query window, then its associated query results are removed from the search results window. Similarly, if a graphical object is partially within the graphical query window, then a corresponding proportion of its associated content is presented in the search results window. In one embodiment, the graphical objects are individually selectable through user gesture to view their associated search query results. Each graphical search query and their variations can be saved by the user. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 shows a generalized flow chart of a graphical search query system as implemented in accordance with an embodiment of the invention;

FIG. 3 depicts a graphical search query system as used to define content classification attributes for content sources;

FIG. 4 depicts a graphical search query system as used to define content classification attributes for content formats;

FIG. 5 depicts a graphical search query system as used to define content classification attributes for content chronology;

FIGS. 6a-b depict a graphical search query system as used to graphically structure search queries according to content source and present their results;

FIG. 7 depicts a graphical search query system as used to graphically structure search queries according to content format and present their results; and

FIG. 8 depicts a graphical search query system as used to graphically structure search queries according to search terms and present their results.

### DETAILED DESCRIPTION

A method, apparatus and computer-usable medium is disclosed for using graphical objects to automate the definition of search queries submitted to an information management system and the presentation of their results. A search query is defined using a plurality of predetermined search terms represented as graphical objects within a user interface. The search query is structured by spatially referencing the graphical objects to a graphical query window within the user interface, resulting in their associated search terms being submitted to an information management system. The results of the search query are then presented in a search results window of the user interface. The graphical objects comprise predetermined classifications of information content segmented by the implementation of display attributes. In different embodiments, the display attributes depict a predetermined classification of information content's source, quantity, format or chronology. In another embodiment, the spatial relationship of the graphical objects to the graphical query window and to each other is configurable to define Boolean relationships for modifying the search query. In these and other embodiments, the search query results presented in the search results window change dynamically as the spatial relationship between the graphical objects are changed relative to each other and the graphical query window. The graphical objects are individually selectable through user gesture to view their associated search query results and each graphical search query can be saved by the user.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

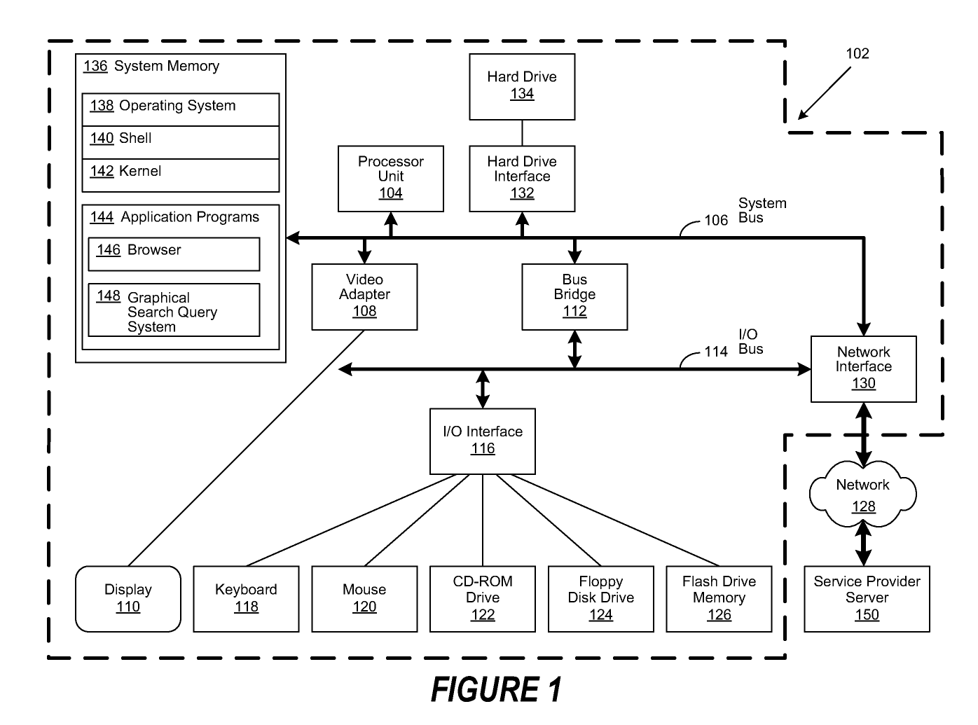

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk—Read Only Memory (CD-ROM) drive 122, a floppy disk drive 124, and a flash drive memory 126. The format of the ports connected to I/0 interface 116 may be any known to those skilled in the art of computer architecture, including but not limited to Universal Serial Bus (USB) ports.

Client computer 102 is able to communicate with a service provider server 150 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 150.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and application programs 144, including memory management, process and task management, disk management, and mouse and keyboard management.

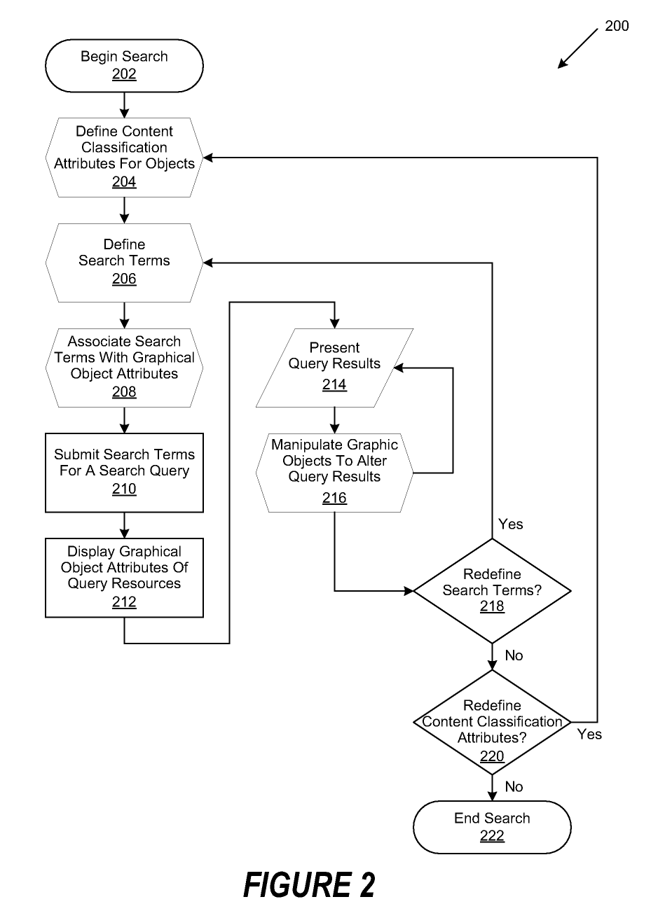

Application programs 144 may include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 150. Application programs 144 also include a graphical search query system 148. Graphical search query system 148 includes code for implementing the processes described in FIGS. 2-8 described herein below. In one embodiment, client computer 102 is able to download the graphical search query system 148 from a service provider server 150.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 shows a generalized flow chart of a graphical search query system 200 as implemented in accordance with an embodiment of the invention. In various embodiments of the invention, graphical search query operations begin in step 202, followed by the definition of content classification attributes in step 204. In one embodiment, the graphic object is a circle representing the classification of content based on its source, such as the public Internet, a private intranet, a customer Web portal, user forums and newsgroups, or file transfer protocol (ftp) sites. Other visual representations may be used, including but not limited to, shape, size, orientation, value, texture, pattern and hue. The circle is segmented into a pie chart, with each segment comprising an attribute such as a color corresponding to the age of the content. For example, a green attribute may signify content that is less than 90 days old, while a blue attribute may signify content that is between three and twelve months old. Similarly, a yellow attribute may signify content that is between one and two years old while a red attribute may signify content that is older than two years. In another embodiment, the graphic object is a circle representing a search term such as key words or search phrases. The circle is similarly segmented into a pie chart, with each segment comprising an attribute such as a color corresponding to the format of the information. For example, a green attribute may signify content stored in the hypertext mark-up language (HTML), while a blue attribute may signify content stored in a proprietary document format such is used by Word, produced by Microsoft. Similarly, a yellow attribute may signify content that is stored in portable document format (pdf) as used in the Acrobat application from Adobe, while an orange attribute may signify content stored in a presentation format and a red attribute may signify content that is stored in a spreadsheet format. It will be apparent to those of skill in the art that the implementation of color and other visual attributes facilitate a user determining the proportion of different content classifications within a predetermined graphical object.

Search terms are defined in step 206, followed by the association of the defined search terms with previously defined graphical object attributes in step 208. The search terms are then submitted to an information management system such as a search engine or a data miner in step 210. Subsequent to submission of the search query, query resources are returned in step 212 and their associated graphical object attributes are displayed within a graphical user interface (GUI). As an example, submission of a search phrase such as “government budget guidance” may return search results that include content stored in HTML, pdf, and proprietary document, spreadsheet and presentation formats. Each of these content format classifications would be presented to the user as a graphical object representing a query resource. Each graphical object would comprise visual attributes as described in greater detail herein to illustrate the proportion of the content within each segment. In one embodiment the available quantity of a predetermined classification of content is indicated by the size of the displayed graphical object. As an example, if a search query returned 1,000 instances of HTML content and 100 instances of pdf content, then the graphical object representing HTML content would be ten times the size of the graphical object representing pdf content.

Once the query resources are presented, the individual query results are presented in step 214. The graphical objects representing the query resources are then manipulated through user gesture such as a mouse click-and-drag operation to alter the query results in step 216. In one embodiment, the results of a search query are altered by spatially referencing two or more graphical objects to a first area of the user interface. In this embodiment, the spatial reference of a graphical object relative to the first area of the user interface is configurable to determine which of the available quantity of a predetermined classification of information content is to be included within the search results presented in a second area of the user interface. In another embodiment, the spatial reference of a plurality of graphical objects relative to each other and to the first area of the user interface is configurable to determine the proportion of each predetermined classification of information content contained within the search results presented in the second area of the user interface. In yet another embodiment, the spatial relationship of the graphical objects within the first area of the user interface is configurable to define Boolean relationships for modifying the search query. For example, if two graphical objects are placed through user gesture to be adjoining each other, then a Boolean AND operation is applied to the search query. In one embodiment, the degree of intersection between two or more graphical objects determines the degree of commonality for search results.

As the spatial relationship between the graphical objects are changed relative to each other and the first area of the user interface, the search query results presented in the second area of the user interface change dynamically. For example, query results associated with graphical objects moved within the first area of the user interface are displayed in the second area of the user interface. If a graphical object is moved out of the first area of the user interface, then its associated query results are removed from the second display area. Similarly, if a graphical object is partially within the first area of the user interface, then a corresponding proportion of its associated content is presented in the second area of the user interface. In these and other embodiments, each graphical object is selectable through user gesture to view its associated search query results in the second area of the user interface. If it is determined in step 218 to redefine the search terms, then the process is repeated beginning in step 206. Otherwise, it is determined in step 220 whether to redefine the content classification attributes. If so, then the process is repeated beginning in step 204. Otherwise, the graphical search query operations end in step 222.

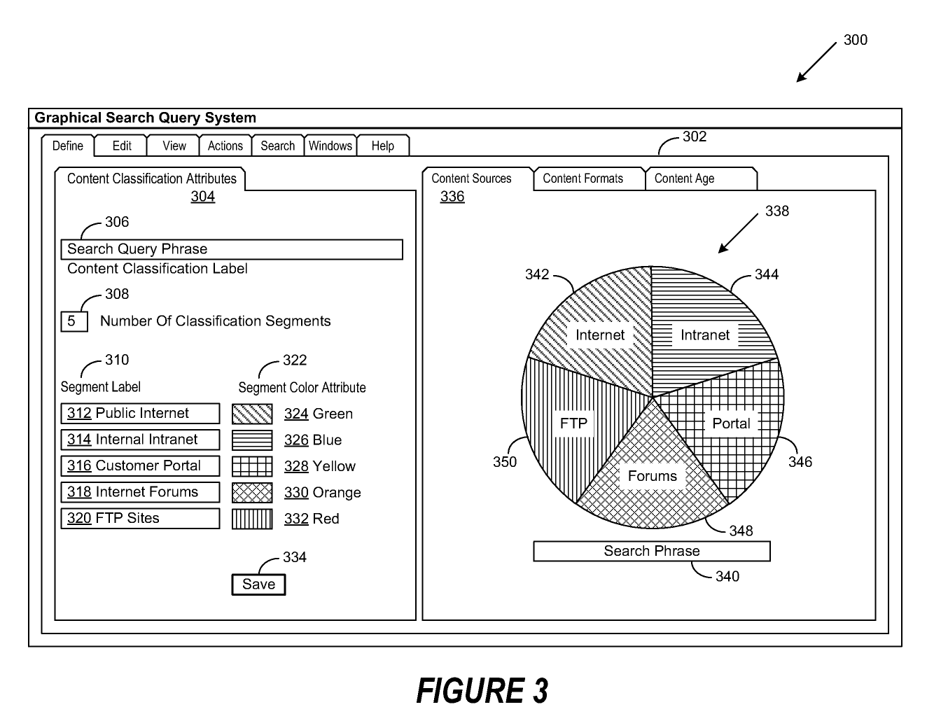

FIG. 3 depicts a graphical search query system 300 as used to define content classification attributes for content sources. In selected embodiments of the invention, graphical search query system user interface 302 comprises content classification attributes definition window 304 and content sources attributes display window 336. Content attributes definition window 304 further comprises content classification label field 306, number of classification segments field 308, segment label fields 310, and segment color attribute fields 322.

In one embodiment, a search query phrase is entered into content classification label field 306 resulting in the display of the search query phrase in the graphical object label field 340 of content sources attributes display window 336. The number of classification segments to be defined is entered into classification segments field 308 resulting in graphical object 338 being segmented into the corresponding number of segments 342, 344, 346, 348 and 350. Segment labels and their corresponding color attributes are then defined in segment label fields 310 and segment color attribute fields 322. In one embodiment, a first segment is labeled “Public Internet” 312 with a segment color attribute of green 324. The label and color attribute are then automatically applied to the corresponding segment 342 of graphical object 338.

In a like fashion, a second segment is labeled “Internal Intranet” 314 with a segment color attribute of blue 326. The label and color attribute are then automatically applied to the corresponding segment 344 of graphical object 338. Likewise, a third segment is labeled “Customer Portal” 316 with a segment color attribute of yellow 328. The label and color attribute are then automatically applied to the corresponding segment 346 of graphical object 338. In a similar fashion, a fourth segment is labeled “Internet Forums” 318 with a segment color attribute of orange 330. The label and color attribute are then automatically applied to the corresponding segment 348 of graphical object 338. Similarly, a fifth segment is labeled “FTP Sites” 320 with a segment color attribute of red 332. The label and color attribute are then automatically applied to the corresponding segment 350 of graphical object 338. Once all segment labels and their corresponding color attributes have been defined in segment label fields 310 and segment color attribute fields 322, they are saved through a user gesture being applied to save button 334.

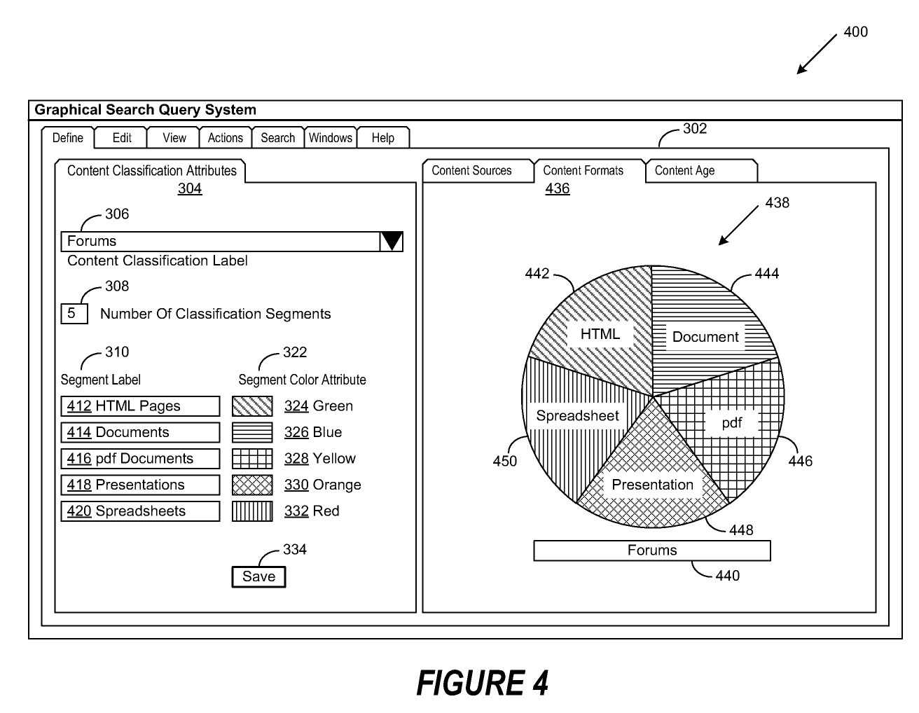

FIG. 4 depicts a graphical search query system 400 as used to define content classification attributes for content formats. In selected embodiments of the invention, graphical search query system user interface 302 comprises content classification attributes definition window 304 and content formats attributes display window 436. Content attributes definition window 304 further comprises content classification label field 306, number of classification segments field 308, segment label fields 310, and segment color attribute fields 322.

In one embodiment, a content source of “Forums” is entered into content classification label field 306 resulting in the display of the content source in the graphical object label field 440 of content sources attributes display window 436. The number of classification segments to be defined is entered into classification segments field 308 resulting in graphical object 438 being segmented into the corresponding number of segments 442, 444, 446, 448 and 450. Segment labels and their corresponding color attributes are then defined in segment label fields 310 and segment color attribute fields 322. In one embodiment, a first segment is labeled “HTML Pages” 412 with a segment color attribute of green 324. The label and color attribute are then automatically applied to the corresponding segment 442 of graphical object 438.

In a like fashion, a second segment is labeled “Documents” 414 with a segment color attribute of blue 326. The label and color attribute are then automatically applied to the corresponding segment 444 of graphical object 438. Likewise, a third segment is labeled “pdf Documents” 416 with a segment color attribute of yellow 328. The label and color attribute are then automatically applied to the corresponding segment 446 of graphical object 438. In a similar fashion, a fourth segment is labeled “Presentations” 418 with a segment color attribute of orange 330. The label and color attribute are then automatically applied to the corresponding segment 448 of graphical object 438. Similarly, a fifth segment is labeled “Spreadsheets” 420 with a segment color attribute of red 332. The label and color attribute are then automatically applied to the corresponding segment 450 of graphical object 438. Once all segment labels and their corresponding color attributes have been defined in segment label fields 310 and segment color attribute fields 322, they are saved through a user gesture being applied to save button 334.

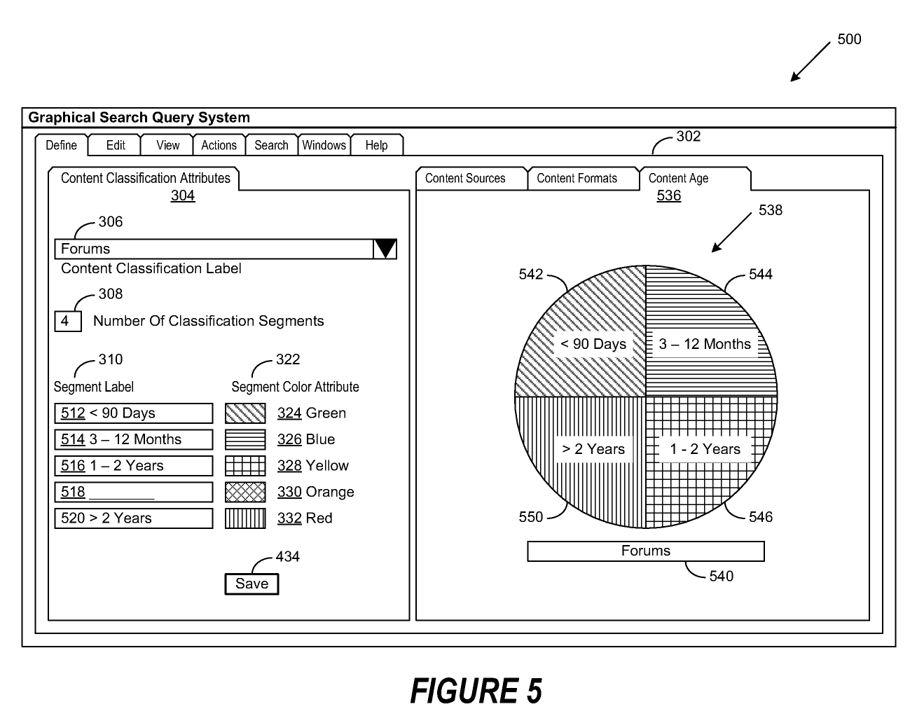

FIG. 5 depicts a graphical search query system 500 as used to define content classification attributes for content chronology. In selected embodiments of the invention, graphical search query system user interface 302 comprises content classification attributes definition window 304 and content age attributes display window 536. Content attributes definition window 304 further comprises content classification label field 306, number of classification segments field 308, segment label fields 310, and segment color attribute fields 322. In one embodiment, a content source of “Forums” is entered into content classification label field 306 resulting in the display of the content source in the graphical object label field 540 of content sources attributes display window 536. The number of classification segments to be defined is entered into classification segments field 308 resulting in graphical object 538 being segmented into the corresponding number of segments 542, 544, 546 and 550. Segment labels and their corresponding color attributes are then defined in segment label fields 310 and segment color attribute fields 322. In one embodiment, a first segment is labeled “<90 Days” 512 with a segment color attribute of green 324. The label and color attribute are then automatically applied to the corresponding segment 542 of graphical object 538.

In a like fashion, a second segment is labeled “3-12 Months” 514 with a segment color attribute of blue 326. The label and color attribute are then automatically applied to the corresponding segment 544 of graphical object 538. Likewise, a third segment is labeled “1-2 Years” 516 with a segment color attribute of yellow 328. The label and color attribute are then automatically applied to the corresponding segment 546 of graphical object 538. Similarly, a fourth segment is labeled “>2 Years” 520 with a segment color attribute of red 332. The label and color attribute are then automatically applied to the corresponding segment 550 of graphical object 538. However, segment label 518, associated with a segment color attribute of orange 330, is left blank. As a result, the blank label 518 and color attribute 330 are not automatically applied to a corresponding segment of graphical object 438. Once all segment labels and their corresponding color attributes have been defined in segment label fields 310 and segment color attribute fields 322, they are saved through a user gesture being applied to save button 434.

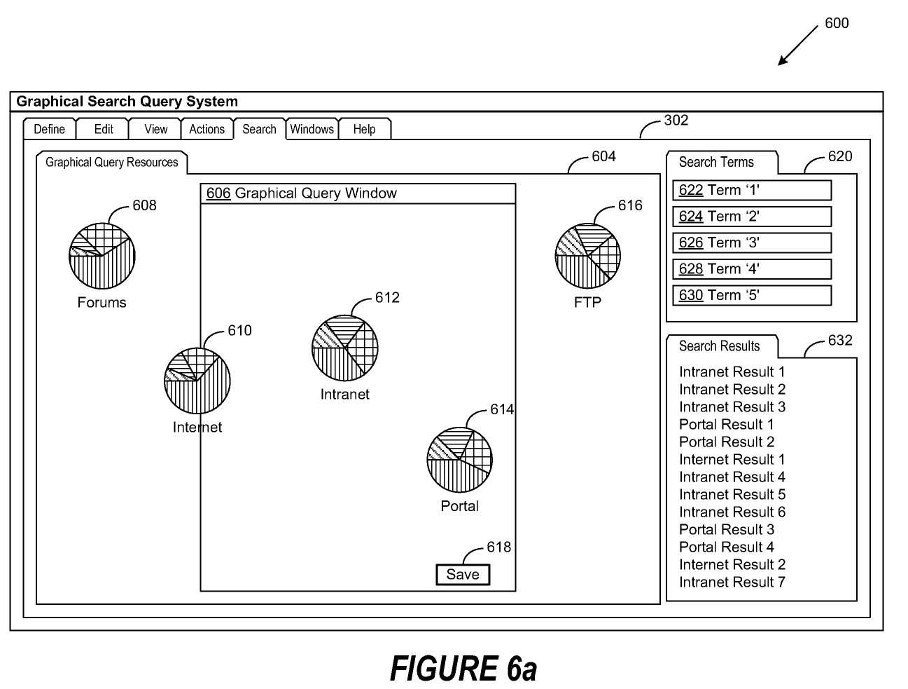

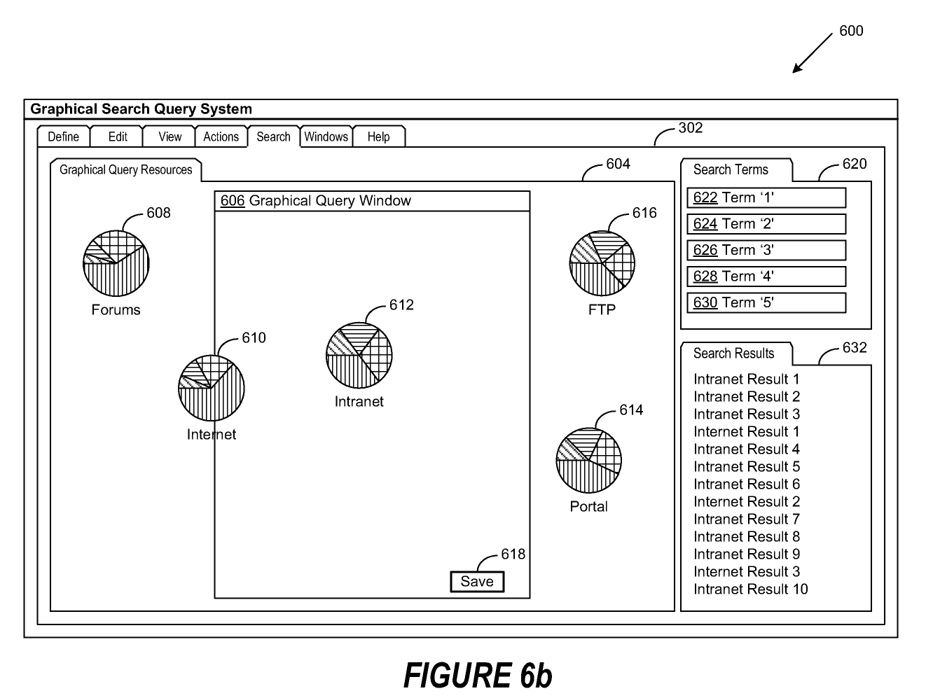

FIGS. 6a-b depict a graphical search query system 600 as used to graphically structure search queries according to content source and present their results. In selected embodiments of the invention, graphical search query system user interface 302 comprises graphical query resources window 604, search term window 620, and search results window 632. FIG. 6a depicts an embodiment where search terms such as key words and search phrases are entered into search term fields ‘1’ through ‘5’ 622, 624, 626, 628, and 630 of search term window 620. Once entered, the search terms are submitted to an information management system such as a search engine or data mining application.

In this embodiment, search query results are returned as graphical query resources represented as graphical objects. Each graphical object is labeled with its respective content source and displays segment attributes corresponding to the age ratio of the content it represents as described in greater detail herein. For example, the graphical object labeled “Forums” 608 displays attributes indicating that a small proportion of the query results returned for Internet newsgroups and forums is less than 90 days old, while a majority of the query results are older than two years. In contrast, the graphical object labeled “FTP” 616 displays attributes that the proportion of query results returned from FTP sites that are less than 90 days old and between three and twelve months are roughly equal.

In one embodiment, the graphical objects labeled “Forums” 608, “Internet” 610, “Intranet” 612, “Portal” 614, and “FTP” 616 are manipulated through user gesture such as a mouse click-and-drag operation to alter the query results displayed in search results window 632. In this embodiment, the results of the search query displayed in search results window 632 are altered by spatially referencing two or more graphical query resources represented by the graphical objects 608, 610, 612, 614, 616 to the graphical query window 606.

The spatial reference of a graphical object relative to the graphical query window 606 is configurable to determine which of the available quantity of a predetermined classification of information content is to be included within the search results presented in search results window 632. For example, as a graphical object is moved towards the center of graphical query window 606, the number of the search results it represents increases in search results window 632. In another embodiment, the spatial reference of the graphical objects 608, 610, 612, 614, 616 relative to each other and to the graphical query window 606 is configurable to determine the proportion of each predetermined classification of information content to be displayed within the search results presented in search results window 632.

For example, in FIG. 6a graphical objects labeled “Forums” 608 and “FTP” 616 are located outside of the graphical query window 606 with the result that their corresponding search query results are not displayed in search results window 632. The graphical object labeled “Intranet” 612 is placed in the center of graphical query window 606, giving it a higher proportional weighting than the graphical object labeled “Portal” 614, which is placed closer to the edge of the graphical query window 606. Correspondingly, the graphical object labeled “Internet” 610 is only partially placed within the graphical query window 606, giving it even less weighting. As a result, the search query results displayed in search results window 632 reflect a proportional weighting of search results represented by each of the graphical objects 610, 612, 614 spatially referenced to graphical query window 606 and to each other.

As illustrated in FIG. 6b, removing the graphical object labeled “Portal” 614 from graphical query window 606 causes a proportional change in the search query results displayed in search results window 632. As a result, no search results are displayed in search results window 632 for information content available from Portal. In these and other embodiment, graphical search queries can be saved through user gestures applied to save button 618.

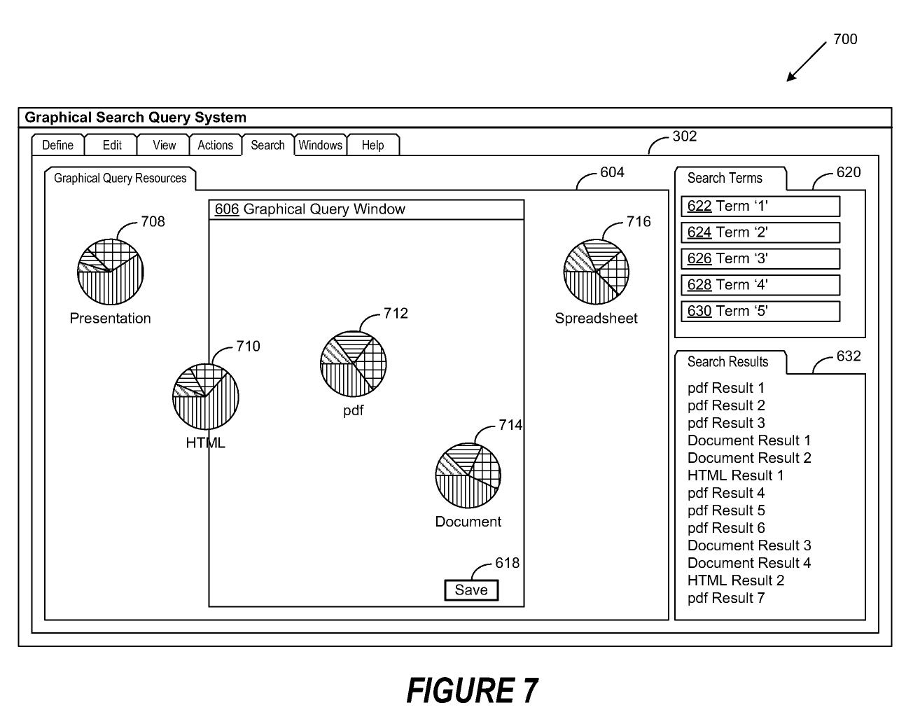

FIG. 7 depicts a graphical search query system 700 as used to graphically structure search queries according to content format and present their results. In selected embodiments of the invention, graphical search query system user interface 302 comprises graphical query resources window 604, search term window 620, and search results window 632. In one embodiment, search terms such as key words and search phrases are entered into search term fields ‘1’ through ‘5’ 622, 624, 626, 628, and 630 of search term window 620. Once entered, the search terms are submitted to an information management system such as a search engine or data mining application.

In this embodiment, search query results are returned as graphical query resources represented as graphical objects. Each graphical object is labeled with its respective content format and displays segment attributes corresponding to the age ratio of the content it represents as described in greater detail herein. For example, the graphical object labeled “Presentation” 708 displays attributes indicating that a small proportion of the query results returned for content stored in a presentation format is less than 90 days old, while a majority of the query results are older than two years. In contrast, the graphical object labeled “Spreadsheet” 716 displays attributes indicating that the proportion of query results returned for content stored in a spreadsheet format that are less than 90 days old and between three and twelve months are roughly equal.

In one embodiment, the graphical objects labeled “Presentation” 708, “HTML” 710, “pdf” 712, “Document” 714, and “Spreadsheet” 716 are manipulated through user gesture such as a mouse click-and-drag operation to alter the query results displayed in search results window 632. In this embodiment, the results of the search query displayed in search results window 632 are altered by spatially referencing two or more graphical query resources represented by the graphical objects 708, 710, 712, 714, 716 to the graphical query window 606.

The spatial reference of a graphical object relative to the graphical query window 606 is configurable to determine which of the available quantity of a predetermined classification of information content is to be included within the search results presented in search results window 632. For example, as a graphical object is moved towards the center of graphical query window 606, the number of the search results it represents increases in search results window 632. In another embodiment, the spatial reference of the graphical objects 708, 710, 712, 714, 716 relative to each other and to the graphical query window 606 is configurable to determine the proportion of each predetermined classification of information content to be displayed within the search results presented in search results window 632.

For example, graphical objects labeled “Presentation” 708 and “Spreadsheet” 716 are located outside of the graphical query window 606 with the result that their corresponding search query results are not displayed in search results window 632. The graphical object labeled “pdf” 712 is placed in the center of graphical query window 606, giving it a higher proportional weighting than the graphical object labeled “Document” 714, which is placed closer to the edge of the graphical query window 606. Correspondingly, the graphical object labeled “HTML” 710 is only partially placed within the graphical query window 606, giving it even less weighting. As a result, the search query results displayed in search results window 632 reflect a proportional weighting of search results represented by each of the graphical objects 710, 712, 714 spatially referenced to graphical query window 606 and to each other. In these and other embodiment, graphical search queries can be saved through user gestures applied to save button 618.

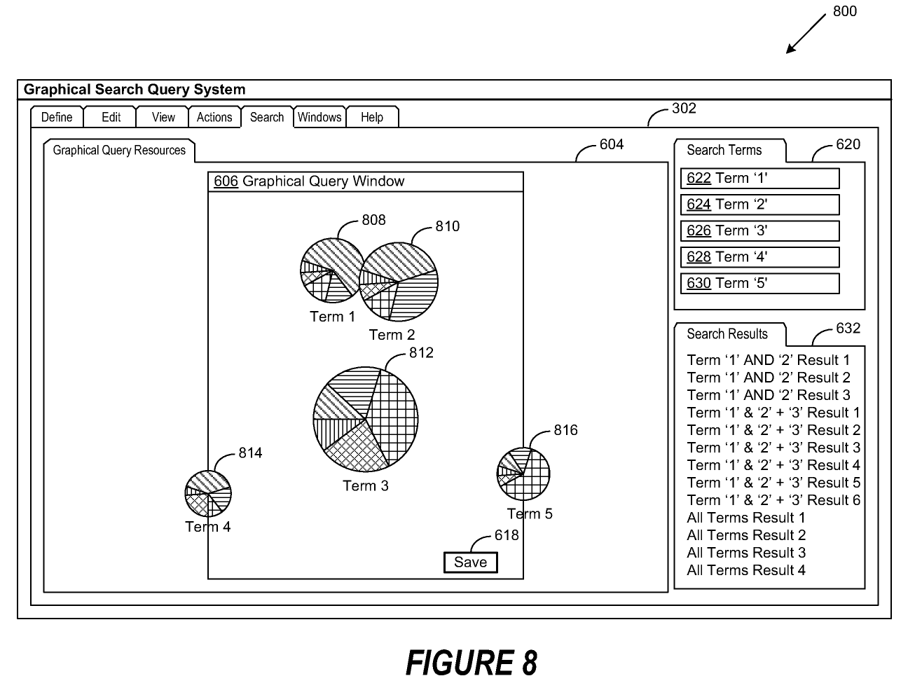

FIG. 8 depicts a graphical search query system 800 as used to graphically structure search queries according to search terms and present their results. In selected embodiments of the invention, graphical search query system user interface 302 comprises graphical query resources window 604, search term window 620, and search results window 632. In one embodiment, search terms such as key words and search phrases are entered into search term fields ‘1’ through ‘5’ 622, 624, 626, 628, and 630 of search term window 620. Once entered, the search terms are submitted to an information management system such as a search engine or data mining application.

In this embodiment, search query results are returned as graphical query resources represented as graphical objects. Each graphical object is labeled with its respective search term and displays segment attributes corresponding to the ratio of the content sources it represents as described in greater detail herein. For example, the graphical object labeled “Term 1” 808 displays attributes indicating that a small proportion of the query results returned are available from FTP sites, while a majority of the query results are available from Internet sites. In contrast, the graphical object labeled “Term 3” 812 displays attributes that the proportion of query results returned for content available from FTP sites and Internet sites are roughly equal. In one embodiment, the graphical objects labeled “Term 1” 808, “Term 2” 810, “Term 3” 812, “Term 4” 814, and “Term 5” 816 are manipulated through user gesture such as a mouse click-and-drag operation to alter the query results displayed in search results window 632. In this embodiment, the results of the search query displayed in search results window 632 are altered by spatially referencing two or more graphical query resources represented by the graphical objects 808, 810, 812, 814, 816 to the graphical query window 606.

The spatial reference of a graphical object relative to the graphical query window 606 is configurable to determine which of the available quantity of a predetermined classification of information content is to be included within the search results presented in search results window 632. For example, as a graphical object is moved towards the center of graphical query window 606, the number of the search results it represents increases in search results window 632. In another embodiment, the spatial reference of the graphical objects 808, 810, 812, 814, 816 relative to each other and to the graphical query window 606 is configurable to determine the proportion of each predetermined classification of information content to be displayed within the search results presented in search results window 632. For example, graphical objects labeled “Term 4” 814 and “Term 5” 816 are located on the periphery of the graphical query window 606 with the result that their corresponding search query results are given less priority in search results window 632.

In yet another embodiment, the spatial relationship of the graphical objects graphical query window 606 is configurable to define Boolean relationships for modifying the search query. If two graphical objects are placed through user gesture to be adjoining each other, then a Boolean AND operation is applied to the search query. In one embodiment, the degree of intersection between two or more graphical objects determines the degree of commonality for search results. For example, the two graphical objects labeled “Term 1” 808 and “Term 2” 810 are manipulated within graphical query window 606 to minimally overlap one another to form a graphical Boolean AND operation. As a result, search results represented by the graphical objects labeled “Term 1” 808 AND “Term 2” 810 are given precedence over other search results displayed in the search results window 632, including those represented by the graphical object labeled “Term 3” 812 even though it too is placed near the center of graphical query window 606. In one embodiment the available quantity of a predetermined classification of content is indicated by the size of the displayed graphical object. As an example, the graphical object labeled “Term 3” 812 is visually larger than either graphical object 808 or 810, and they are visually larger than graphical objects 814 and 816, signifying a proportional weighting of available content for each of their associated search terms.

As will be apparent to those of skill in the art, the search query results presented in the search results window 632 change dynamically as the spatial relationship between the graphical objects 808, 810, 812, 814, 816 are changed relative to each other and the graphical query window 606. For example, if a graphical object is moved out of the graphical query window 606, then its associated query results are removed from the search results window 632. Similarly, if a graphical object is partially within the graphical query window 606, then a corresponding proportion of its associated content is presented in the search results window 632. In one embodiment, the graphical objects 808, 810, 812, 814, 816 are individually selectable through user gesture to view their associated search query results in the search results window 632. In these and other embodiment, graphical search queries can be saved through user gestures applied to save button 618.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for searching and presenting information stored in a plurality of forms in an information management system, comprising:
defining a search query using a plurality of predetermined search terms;
representing the plurality of predetermined search terms as graphical objects within a user interface;
structuring the search query by spatially referencing the graphical objects to a first area of the user interface;
submitting the search query to the information management system; and
presenting results of the search query as search query results within a second area of the user interface.

2. The method of claim 1, wherein the graphical objects comprise display attributes, the display attributes being configurable to depict at least one of an available quantity of a predetermined classification of information content and segmentation of a predetermined classification of information content.

3. The method of claim 1, wherein the spatial reference of a graphical object relative to the first area of the user interface is configurable to determine which of the available quantity of a predetermined classification of information content is to be included within the search results presented in the second area of the user interface.

4. The method of claim 3, wherein the spatial reference of a plurality of graphical objects relative to each other and to the first area of the user interface is configurable to determine the proportion of each predetermined classification of information content contained within the search results presented in the second area of the user interface.

5. The method of claim 1, wherein each graphical object is selectable to view associated search query results in the second area of the user interface.

6. The method of claim 1, wherein the search query results presented in the second area of the user interface dynamically change as the spatial relationship between the graphical objects are changed in the first area of the user interface.

7. A system comprising:
a processor;
a data bus coupled to the processor; and
a computer-usable medium embodying computer program code, the computer-usable medium being coupled to the data bus, the computer program code comprising instructions executable by the processor and configured for:
defining a search query using a plurality of predetermined search terms;
representing the plurality of predetermined search terms as graphical objects within a user interface;
structuring the search query by spatially referencing the graphical objects to a first area of the user interface;
submitting the search query to the information management system; and
presenting results of the search query as search query results within a second area of the user interface.

8. The system of claim 7, wherein:
the graphical objects comprise display attributes, the display attributes being configurable to depict at least one of an available quantity of a predetermined classification of information content and segmentation of a predetermined classification of information content.

9. The system of claim 7, wherein
the spatial reference of a graphical object relative to the first area of the user interface is configurable to determine which of the available quantity of a predetermined classification of information content is to be included within the search results presented in the second area of the user interface.

10. The system of claim 9, wherein
the spatial reference of a plurality of graphical objects relative to each other and to the first area of the user interface is configurable to determine the proportion of each predetermined classification of information content contained within the search results presented in the second area of the user interface.

11. The system of claim 7, wherein
each graphical object is selectable to view associated search query results in the second area of the user interface.

12. The system of claim 7, wherein
the search query results presented in the second area of the user interface dynamically change as the spatial relationship between the graphical objects are changed in the first area of the user interface.

13. A computer-usable medium embodying computer program code, the computer program code comprising computer executable instructions configured for:
defining a search query using a plurality of predetermined search terms;
representing the plurality of predetermined search terms as graphical objects within a user interface;
structuring the search query by spatially referencing the graphical objects to a first area of the user interface;
submitting the search query to the information management system; and
presenting results of the search query as search query results within a second area of the user interface.

14. The computer-usable medium of claim 13, wherein:
the graphical objects comprise display attributes, the display attributes being configurable to depict at least one of an available quantity of a predetermined classification of information content and segmentation of a predetermined classification of information content.

15. The computer-usable medium of claim 13, wherein
the spatial reference of a graphical object relative to the first area of the user interface is configurable to determine which of the available quantity of a predetermined classification of information content is to be included within the search results presented in the second area of the user interface.

16. The computer-usable medium of claim 15, wherein
the spatial reference of a plurality of graphical objects relative to each other and to the first area of the user interface is configurable to determine the proportion of each predetermined classification of information content contained within the search results presented in the second area of the user interface.

17. The computer-usable medium of claim 13, wherein
each graphical object is selectable to view associated search query results in the second area of the user interface.

18. The computer-usable medium of claim 13, wherein
the search query results presented in the second area of the user interface dynamically change as the spatial relationship between the graphical objects are changed in the first area of the user interface.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
